(19) United States
(12) Patent Application Publication
(10) Pub. No.: US 2025/0343270 A1
(43) Pub. Date: Nov. 6, 2025

(54) ELECTROLYTE FORMULATIONS

(71) Applicants: Silatronix, Inc., Madison, WI (US); Mexichem Fluor Inc., St. Gabriel, LA (US)

(72) Inventors: Sarah Guillot, Madison, WI (US); Monica Usrey, Madison, WI (US); Peng Du, Madison, WI (US); Andrew Sharratt, Runcorn (GB); Tobias Johnson, Madison, WI (US); Suresh Sriramulu, Waltham, MA (US)

(21) Appl. No.: 18/653,357

(22) Filed: May 2, 2024

(51) Int. Cl. H01M 10/0569

(52) U.S. Cl. CPC H01M 10/0569; H01M 2300/0034; H01M 2300/0037

(57) ABSTRACT

Battery electrolyte formulations comprising fluorine-containing dioxolane compounds as an organic solvent, suitable for use in energy storage devices including batteries and capacitors, especially for secondary batteries and devices known as supercapacitors.

### FIELD OF THE INVENTION

Disclosed herein are battery electrolyte formulations comprising fluorine-containing dioxolane compounds as an organic solvent. These formulations are suitable for use in energy storage devices including batteries and capacitors, especially for secondary batteries and devices known as supercapacitors.

### BACKGROUND

There are two main types of batteries: primary and secondary. Primary batteries are also known as non-rechargeable batteries. Secondary batteries are also known as rechargeable batteries. A well-known type of rechargeable battery is the lithium-ion battery. Lithium-ion batteries have a high energy density, no memory effect and low self-discharge.

Lithium-ion batteries are commonly used for portable electronics and electric vehicles. In the batteries lithium ions move from the negative electrode to the positive electrode during discharge and back when charging.

Typically, the electrolytic solutions include a nonaqueous solvent and an electrolyte salt, plus additives. The electrolyte is typically a mixture of organic carbonates such as ethylene carbonate, propylene carbonate, fluoroethylene carbonate and dialkyl carbonates, containing a lithium-ion electrolyte salt. Many lithium salts can be used as the electrolyte salt; common examples include lithium hexafluorophosphate (LiPF₆), lithium bis (fluorosulphonyl)imide “LiFSI” and lithium bis(trifluoromethanesulphonyl)imide (LiTFSI).

The electrolytic solution has to perform a number of separate roles within the battery.

The principal role of the electrolyte is to facilitate the flow of charge carriers between the cathode and anode. This occurs by transportation of metal ions within the battery to or from one or both of the anode and cathode, whereby on chemical reduction or oxidation, electrical charge is liberated/adopted.

Thus, the electrolyte needs to provide a medium which is capable of solvating and/or supporting the metal ions.

Due to the use of lithium electrolyte salts and the interchange of lithium ions with lithium metal, which is very reactive with water, as well as the sensitivity of other battery components to water, the electrolyte is usually non-aqueous.

Additionally, the electrolyte has to have suitable rheological properties to permit/enhance the flow of ions therein, at the typical operating temperature to which a battery is exposed and is expected to perform.

Moreover, the electrolyte has to be as chemically inert as possible. This is particularly relevant in the context of the expected lifetime of the battery regarding internal corrosion within the battery (e.g. of the electrodes and casing) and the issue of battery leakage. Also of importance within the consideration of chemical stability is flammability. Unfortunately, typical electrolyte solvents can be a safety hazard, since they often comprise a flammable material.

This can be problematic as in operation, when discharging or being discharged, batteries may accumulate heat. This is especially true for high density batteries such as lithium-ion batteries. It is therefore desirable that the electrolyte displays a low flammability, with other related properties such as a high flash point.

Electrolytes may also have an important impact on some of the operational requirements of modern batteries. For example, it is increasingly necessary that batteries may be charged quickly and can maintain a consistent discharge and capacity through a large number of charge cycles. Moreover, batteries are required to be deployed in many different temperature conditions and it is desirable that such performance can be delivered at high, low and ambient temperatures.

It is therefore important that an electrolyte ensures long term operation after many multiples of fast charging cycles, and during high and low temperature battery cycling. Fast charge battery cycling and high temperature battery cycling can lead to lithium plating at the anodes in a battery, increased gassing formed by unwanted electrolysis of the electrolyte, and increased impedance. All of these effects are undesirable and are associated with worsened cycling stability.

It is also important that the conducting salt has good solubility in the electrolyte. Low solubility of the conducting salt in the electrolyte leads to poor conductance, whereas high solubility leads to good conductance. Good conductance is highly desirable in batteries.

It is also desirable that the electrolyte does not present or at least minimises an environmental issue with regard to disposability after use or other environmental issue such as global warming potential.

The listing or discussion of an independently prior published document in this specification should not necessarily be taken as an acknowledgement that the document is part of the state of the art or is common general knowledge.

It is an object of the present invention to provide a nonaqueous electrolytic solution, which provides improved properties over the nonaqueous electrolytic solution of the prior art.

### Electrolyte Formulation Aspects

According to a first aspect of the invention there is provided a battery electrolyte formulation comprising
a charge carrying species;
one or more solvents; and
a compound of Formula 1:

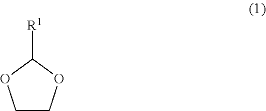

wherein R¹ is a fluorinated methyl group,
wherein the compound of Formula 1 is present in an amount of 1 to 30% by weight of the liquid component of the battery electrolyte formulation.

In one embodiment, R¹ is CHF₂ or CF₃. Preferably, R¹ is CF₃.

In another embodiment, the compound of Formula 1 is present in an amount of 2 to 25% by weight of the liquid component of the battery electrolyte formulation, preferably 6 to 25%, such as 12 to 25%.

In a further embodiment, diethyl sulfone is present in an amount of less than 30% by weight of the liquid component of the battery electrolyte formulation.

According to a second aspect of the invention there is provided a battery electrolyte formulation comprising
a charge carrying species;
one or more solvents; and
a compound of Formula 2:

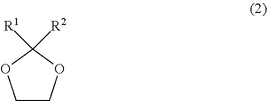

wherein R¹ and R² are H or a fluorinated methyl group, and at least one of R¹ and R² is a fluorinated methyl group,
wherein the compound of Formula 2 is present in an amount of 1 to 30% by weight of the liquid component of the battery electrolyte formulation,
wherein diethyl sulfone is present in an amount of less than 30% by weight of the liquid component of the battery electrolyte formulation.

In one embodiment, R¹ and R² are both CF₃.

In another embodiment, R¹ is H, and R² is CHF₂ or CF₃. Preferably, R¹ is H, and R² is CF₃.

In a further embodiment, the compound of Formula 2 is present in an amount of 2 to 25% by weight of the liquid component of the battery electrolyte formulation, preferably 6 to 25%, such as 12 to 25%.

The battery electrolyte formulations of the first and second aspects of the invention have been found to be surprisingly advantageous. The presence of compounds of Formula 1 or Formula 2 in an amount of 1 to 30% by weight of the liquid component of the battery electrolyte formulation results in beneficial properties. These beneficial properties are manifested during fast charge battery cycling, high temperature battery cycling and low temperature battery cycling. The battery electrolyte formulations comprising Formula 1 or Formula 2 in an amount of 1 to 30% by weight of the liquid component also exhibit good solubility of the metal electrolyte salt.

The advantages of using the above-described battery electrolyte formulations in batteries during fast charge battery cycling include improved cycling stability, improved capacity retention, improved coulombic efficiency, reduced impedance, reduced direct current internal resistance (DCIR), reduced gassing, and reduced lithium plating. These advantages manifest themselves over at least the first 500 cycles.

The advantages of using the above-described battery electrolyte formulations in batteries during high temperature cycling after low temperature rate tests include improved cycling stability, reduced impedance, reduced DCIR, reduced gassing, improved retained nickel content, and reduced voltage hysteresis.

Preferably, in any of the above formulations, the charge carrying species comprises a metal electrolyte salt.

In one embodiment, the metal electrolyte salt is present in a concentration of 0.1 to 2M, preferably 1M.

In an embodiment, the metal electrolyte salt is present in an amount of 0.1 to 20% by weight of the liquid component of the battery electrolyte formulation.

In an embodiment, the metal salt is a salt of lithium, a salt of sodium, a salt of potassium, a salt of magnesium, or mixtures thereof.

In an embodiment, the metal salt comprises one or more salts of lithium, sodium, potassium, magnesium, borate, phosphate, and the like. Non-limiting examples include lithium hexafluorophosphate (LiPF₆), lithium perchlorate (LiClO₄), lithium tetrafluoroborate (LiBF₄), lithium triflate (LiSO₃CF₃), lithium bis(fluorosulphonyl)imide (Li(FSO₂)₂N), lithium bis(trifluoromethanesulphonyl)imide (Li(CF₃SO₂)₂N), lithium bis(oxalato)borate (LiBOB), lithium difluoro(oxalato)borate (LiFDOB), sodium hexafluorophosphate (NaPF₆), sodium tetrafluoroborate (NaBF₄), sodium perchlorate (NaClO₄), potassium hexafluorophosphate (KPF₆), potassium tetrafluoroborate (KBF₄), potassium perchlorate (KClO₄), magnesium hexafluorophosphate (MgPF₆), magnesium perchlorate (MgClO₄), magnesium tetrafluoroborate (MgBF₄), preferably lithium hexafluorophosphate (LiPF₆).

In an embodiment, the one or more solvents are present in an amount of from 60 to 99% by weight of the liquid component of the battery electrolyte formulation, preferably 60 to 97%, more preferably 73 to 97%, such as 73 to 93%, for example 73 to 86%.

In an embodiment, at least one of the one or more solvents is selected from the group comprising ethylene carbonate (EC), diethyl carbonate (DEC), ethyl methyl carbonate (EMC), dimethyl carbonate (DMC), propylene carbonate (PC), gamma-butyrolactone, fluoroethylene carbonate (FEC), fluoroethyl methyl carbonate (FEMC), esters such as but not limited to methyl propionate, methyl butyrate, methyl acetate, ethyl acetate, ethyl propionate, ethyl butyrate, propyl acetate, propyl propionate, propyl butyrate, various fluorine-containing linear or cyclic carbonates, and mixtures thereof.

In an embodiment, at least one of the one or more solvents is selected from the group comprising ethylene carbonate (EC), diethyl carbonate (DEC), ethyl methyl carbonate (EMC), and mixtures thereof.

The battery electrolyte formulation may include an additive.

Suitable additives may serve as surface film-forming agents, which form an ion permeable film on the surface of the positive electrode and/or the negative electrode. This can pre-empt a decomposition reaction of the nonaqueous electrolytic solution and the electrolyte salt occurring on the surface of the electrodes, thereby preventing the decomposition reaction of the nonaqueous electrolytic solution on the surface of the electrodes.

Examples of film-forming agent additives include vinylene carbonate (VC), ethylene sulfite (ES), ethylene sulfate (DTD), lithium bis(oxalato)borate (LiBOB), cyclohexylbenzene (CHB), fluoroethylene carbonate (FEC), lithium difluorophosphate (LiPO₂F₂), succinonitrile (SN), adiponitrile (ADN), ethyleneglycol bis(2-cyanoethyl)ether (EGPN), 1,3-propane sultone (PS), tris(trimethylsilyl) phosphate (TTSP), tris(trimethylsilyl) phosphite (TTSPi), methylene methanedisulfonate (MMDS), trimethylene sulfate (TMS), prop-1-ene-1,3-sultone (PES), propargyl methane sulfonate (PMS), allyl methane sulfonate (AMD), succinic anhydride (SA), dimethyl acetamide (DMA), and ortho-terphenyl (OTP). The additives may be used singly, or two or more may be used in combination.

In an embodiment, the formulations further comprise vinylene carbonate (VC).

In a further embodiment the vinylene carbonate (VC) is present in an amount of 0.1 to 5.0% by weight of the liquid component of the formulation, preferably 1 to 1.5%.

Sulfones have high viscosity and low ionic conductivities in the presence of lithium salt. Sulfones also often have an unpleasant odour and typically incompatible with lithium and graphite anodes. Accordingly, battery electrolyte formulations with lower amounts of sulfones are preferred.

In one embodiment, the formulations comprise less than 20% diethyl sulfone (for example less than 15%, 10% or 5% diethyl sulfone) by weight of the battery electrolyte formulation.

In another embodiment, the formulations are substantially free from diethyl sulfone.

### Preparation of Compounds

Compounds of Formula 1 can be prepared by reaction of a substituted ethyl acetate of formula CHXCH₂OCOR¹, with a reducing agent, such as sodium hydride, in the presence of DMSO:

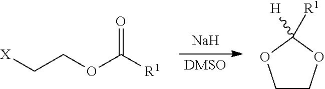

wherein R¹ is a fluorinated methyl group; and
X is a leaving group, such as —OH, —Cl, —Br.

Compounds of Formula 2 can be prepared in high yield and selectively by reaction of a substituted ketone with a compound of formula CHXCH₂OH, preferably under acidic and dehydrating conditions:

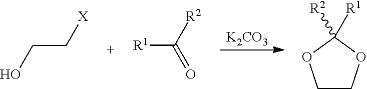

wherein R¹ and R² are a fluorinated methyl group; and
X is a leaving group, such as —OH, —Cl, —Br.

### Battery Aspects

### Electrochemical Cell

According to a third aspect of the invention there is provided an electrochemical cell comprising an anode, a cathode, a separator membrane and an electrolyte formulation as described above.

Usually the electrodes are porous and permit metal ions (lithium ions) to move in and out of their structures with a process called insertion (intercalation) or extraction (deintercalation).

### Positive Electrode (Cathode)

For rechargeable batteries (secondary batteries), the term cathode designates the electrode where reduction is taking place during the discharge cycle. For lithium-ion cells the positive electrode (“cathode”) is the lithium-based one.

The positive electrode (cathode) is generally composed of a positive electrode current collector such as a metal foil, optionally with a positive electrode active material layer disposed on the positive electrode current collector.

The positive electrode current collector may be a foil of a metal that is stable at a range of potentials applied to the positive electrode, or a film having a skin layer of a metal that is stable at a range of potentials applied to the positive electrode. Aluminium (Al) is desirable as the metal that is stable at a range of potentials applied to the positive electrode.

In one embodiment the cathode comprises a lithium metal oxide.

In a further embodiment, the lithium metal oxide is lithium nickel manganese cobalt oxide, such as wherein the nickel to manganese to cobalt ratio is 8:1:1. The cathode may also comprise lithium iron phosphate (LFP), lithium cobalt oxide (LCO), lithium manganese oxide (LMO), lithium nickel oxide (LNO), lithium-rich metal oxides, lithium nickel manganese cobalt oxide (NMC), lithium nickel cobalt aluminium oxide (NCA), or other lithium, sodium, or potassium intercalation or conversion cathode materials.

The positive electrode active material layer generally includes a positive electrode active material, and other components such as a conductive agent and a binder. This is generally obtained by mixing the components in a solvent, applying the mixture onto the positive electrode current collector, followed by drying and rolling.

A conductive agent may be used to increase the electron conductivity of the positive electrode active material layer.

A binder may be used to ensure good contact between the positive electrode active material and the conductive agent, and to increase the adhesion of the components such as the positive electrode active material with respect to the surface of the positive electrode current collector.

The binder may be selected from the group including polyvinylidene fluoride (PVDF), polyacrylic acid (PAA), polytetrafluoroethylene (PTFE), carboxymethyl cellulose (CMC), polyimide (PI), polyaniline (PANI), styrene butadiene rubber (SBR), polymethyl methacrylate (PMMA), lithium polyacrylate (Li-PAA), hexafluoropropylene (HFP), polyvinyl alcohol (PVA), and mixtures of these. Preferably, the binder is polyvinylidene fluoride (PVDF).

### Negative Electrode (Anode)

The negative electrode (anode) is generally composed of a negative electrode current collector such as a metal foil, optionally with a negative electrode active material layer disposed on the negative electrode current collector.

The negative electrode current collector may be a foil of a metal. Copper (lithium free) is suitable as the metal. Copper is easily processed at low cost and has good electron conductivity.

The anode may be selected from the group including graphite, graphite composites, and hard carbon. In one embodiment, the anode comprises graphite.

### Separator

A separator is preferably present between the positive electrode and the negative electrode. The separator has insulating properties. The separator may comprise a porous film having ion permeability. Examples of porous films include microporous thin films, woven fabrics and nonwoven fabrics. Suitable materials for the separators are polyolefins, such as polyethylene and polypropylene.

In one embodiment, the separator membrane comprises polyethylene.

### Battery

According to a fourth aspect of the invention there is provided a battery comprising two or more electrochemical cells as described above.

The battery may comprise a primary (non-rechargeable) or a secondary battery (rechargeable). Most preferably the battery comprises a secondary battery.

A battery comprising the nonaqueous electrolytic solutions will generally comprise several elements. Elements making up the preferred nonaqueous electrolyte secondary battery cell are described below. It is appreciated that other battery elements may be present (such as a temperature sensor); the list of battery components below is not intended to be exhaustive.

### Case

The battery components are preferably contained within a protective case.

The case may comprise any suitable material which is resilient to provide support to the battery and an electrical contact to the device being powered.

In one embodiment the case comprises a metal material, preferably in moulded sheet form.

In another embodiment the case comprises a plastics material, such as in moulded form. The case may also comprise other additives for the plastics material, such as fillers or plasticisers. In this embodiment wherein the case for the battery predominantly comprises a plastics material, a portion of the casing may additionally comprise a conductive/metallic material to establish electrical contact with the device being powered by the battery.

### Arrangement

The positive electrode and negative electrode may be wound or stacked together through a separator. Together with the nonaqueous electrolytic solution they are accommodated in the exterior case. The positive and negative electrodes are electrically connected to the exterior case in separate portions thereof.

### Module/Pack

A number/plurality of battery cells may be made up into a battery module. In a battery module the battery cells may be organised in series and/or in parallel. Typically, these are encased in a mechanical structure.

A battery pack may be assembled by connecting multiple modules together in a series or parallel. Typically, battery packs include further features such as sensors and controllers including battery management systems and thermal management systems. The battery pack generally includes an encasing housing structure to make up the final battery pack product.

### End Uses

The battery of the invention, in the form of an individual battery/cell, module and/or pack (and the electrolyte formulations therefor) are intended to be used in one or more of a variety of end products. Examples of end products include portable electronic devices, such as GPS navigation devices, cameras laptops, tablets and mobile phones. Other preferred examples of end products include vehicular devices (as provision of power for the propulsion system and/or for any electrical system or devices present therein), such as electrical bicycles and motorbikes, as well as automotive applications (including hybrid and purely electric vehicles).

### Method Aspects

A method of improving cycling stability during fast charge battery cycling or within a battery, the method comprising including in at least one cell of the battery an electrolyte formulation as described above.

A method of reducing lithium plating during fast charge battery cycling within a battery, the method comprising including in at least one cell of the battery an electrolyte formulation as described above.

A method of reducing gassing during fast charge battery cycling within a battery, the method comprising including in at least one cell of the battery an electrolyte formulation as described above.

A method of reducing impedance during fast charge battery cycling within a battery, the method comprising including in at least one cell of the battery an electrolyte formulation as described above.

A method of improving cycling stability during high temperature battery cycling within a battery, the method comprising including in at least one cell of the battery an electrolyte formulation as described above.

A method of reducing gassing during high temperature battery cycling within a battery, the method comprising including in at least one cell of the battery an electrolyte formulation as described above.

A method of reducing impedance during high temperature battery cycling within a battery, the method comprising including in at least one cell of the battery an electrolyte formulation as described above.

A method of improving cycling stability during low temperature battery cycling within a battery, the method comprising including in at least one cell of the battery an electrolyte formulation as described above.

A method of reducing impedance during low temperature battery cycling within a battery, the method comprising including in at least one cell of the battery an electrolyte formulation as described above.

Preferences and options for any given aspect, feature or parameter of the invention should, unless the context indicates otherwise, be regarded as having been disclosed in combination with any and all preferences and options for all other aspects, features and parameters of the invention.

### BRIEF DESCRIPTION OF THE DRAWINGS

FIG. 1A shows Discharge Capacity (mAh) against Cycle Number for electrolyte compositions containing 2, 5, 10 and 20 vol. % 2-trifluoromethyl-1,3-dioxolane (F-DOL1), and a control electrolyte composition over 500 cycles of 4 C fast charge cycling at 30° C. in 4.3V NMC811/Gr pouch cells. FIG. 1B is a histogram showing Discharge Capacity after the 100^{th}, 300^{th}, and 470^{th} cycles. (Control electrolyte: EC/DEC/EMC (1/1/1, % v)+1% VC+1M LiPF₆. The same control was used in all the figures.)

FIG. 2A shows Capacity Retention (%) against Cycle Number for electrolyte compositions containing 2, 5, 10 and 20 vol. % F-DOL1, and the control electrolyte composition over 500 cycles of 4C fast charge cycling at 30° C. in 4.3V NMC811/Gr pouch cells. FIG. 2B is a histogram showing Capacity Retention after the 100^{th}, 300^{th}, and 470^{th} cycles.

FIG. 3 shows Impedance (Ohms) (measured at 30° C.) and Cycle Number for electrolyte compositions containing 2, 5, 10 and 20 vol. % F-DOL1, and the control electrolyte composition at selected cycles of 4C fast charge cycling at 30° C. in 4.3V NMC811/Gr pouch cells.

FIG. 4 shows Gas Volume Change (mL) and Cycle Number for electrolyte compositions containing 2, 5, 10 and 20 vol. % F-DOL1, and the control electrolyte composition at selected cycles of 4C fast charge cycling at 30° C. in 4.3V NMC811/Gr pouch cells.

FIG. 5 shows photos of the anode after 480 cycles of 4C fast charge cycling for electrolyte compositions containing 2, 5, 10 and 20 vol. % F-DOL1, and the control electrolyte composition. Light areas indicate lithium plating.

FIG. 6 shows Metal Content of the Anode (ppm) measured by inductively coupled plasma (ICP) of manganese for electrolyte compositions containing 2, 5, 10, and 20 vol. % F-DOL1 and the control electrolyte composition after 480 cycles of 4C fast charge cycling.

FIG. 7A shows Discharge Capacity (mAh) for electrolyte compositions containing 20 vol. % F-DOL1 and the control electrolyte composition at C/2 discharge, 1C discharge, and 2C discharge cycling at 0° C. (all C/2 charge) between cycles at C/2 charge/discharge and 30° C. FIG. 7B is a histogram showing Discharge Capacity at C/2, 1C, and 2C.

FIG. 8A shows Discharge Capacity (mAh) against Cycle Number for electrolyte compositions containing 20 vol. % F-DOL1 and the control electrolyte composition over 300 cycles at 45° C., following the 0° C. rate test shown in FIG. 7A. FIG. 8B is a histogram showing Discharge Capacity after 1^{st}, 100^{th}, 200^{th}, and 300^{th} cycles.

FIG. 9 shows Cell Impedance (Ohms) (measured at 30° C.) and Cycle Number for electrolyte compositions containing 20 vol. % F-DOL1 and the control electrolyte composition over 300 cycles at 45° C., following the 0° C. rate test shown in FIG. 7A.

FIG. 10 shows Cell Gas Volume Change (mL) and Cycle Number for electrolyte compositions containing 20 vol. % F-DOL1 and the control electrolyte composition over 300 cycles at 45° C., following the 0° C. rate test shown in FIG. 7A.

FIG. 11 shows Metal Content of the Anode (ppm) measured by inductively coupled plasma (ICP) of manganese for electrolyte compositions containing 20 vol. % F-DOL1 and the control electrolyte composition after the last cycle over 300 cycles at 45° C., following the 0° C. rate test shown in FIG. 7A.

FIG. 12A shows Elemental Composition (%) and Sputter Time (s) from x-ray photoelectron spectroscopy (XPS) depth profiling of the anodes from cells containing the control electrolyte composition or an electrolyte composition containing 20 vol. % F-DOL1, after 300 cycles at 45° C. which followed a 0° C. rate test. FIG. 12B shows an exemplary XPS spectrum (Electron counts vs. binding energy (eV) from this testing.

FIG. 13 shows Discharge Capacity (mAh) against Cycle Number for electrolyte compositions containing 5, 10 and 20 vol. % F-DOL1, and the control electrolyte composition over 30 cycles at 30° C. followed by 700 cycles at 45° C.

FIG. 14 shows Normalized Discharge Capacity against Cycle Number for electrolyte compositions containing 5, 10 and 20 vol. % F-DOL1, and the control electrolyte composition over 30 cycles at 30° C. followed by 700 cycles at 45° C.

FIG. 15 shows Impedance (Ohms) (measured at 30° C.) and Cycle Number for electrolyte compositions containing 5, 10 and 20 vol. % F-DOL1, and the control electrolyte composition after formation, after 300 cycles at 45° C., and after 600 cycles at 45° C.

FIG. 16 shows Cell Gas Volume Change (mL) and Cycle Number for electrolyte compositions containing 5, 10 and 20 vol. % F-DOL1, and the control electrolyte composition after 300 cycles at 45° C. and after 600 cycles at 45° C.

FIG. 17 shows Discharge Capacity (mAh) against Cycle Number for electrolyte compositions containing 20 vol. % 2-difluoromethyl-1,3-dioxolane (F-DOL2) and the control electrolyte composition over 400 cycles at 45° C.

FIG. 18 shows Cell Gas Volume Change (mL) and Cycle Number for electrolyte compositions containing 20 vol. % F-DOL2 and the control electrolyte composition over 400 cycles at 45° C.

FIGS. 19A, 19B, and 19C show Discharge Capacity (mAh) during sequential discharge rate tests (C/2, 1C, 2C, and back to C/2) at 0° C. (FIG. 19A), −10° C. (FIG. 19B), and −20° C. (FIG. 19C) for electrolyte compositions containing 20 vol. % F-DOL1 and the control electrolyte composition.

FIG. 20 shows Discharge Capacity (mAh) after 1 cycle and after 100 cycles at 0° C. (following the 0° C., −10° C., and −20° C. rate test in FIG. 19) for electrolyte compositions containing 20 vol. % F-DOL1 and the control electrolyte composition.

FIGS. 21A, 21B, and 21C show Impedance (Ohms) measured at 0° C. (FIG. 21A), −10° C. (FIG. 21B), and −20° C. (FIG. 21C) following cycling for 100 cycles at 0° C. after the 0° C., −10° C., and −20° C. rate test in FIG. 19 for electrolyte compositions containing 20 vol. % F-DOL1 and the control electrolyte composition.

FIG. 22 shows Discharge capacity (mAh) at 100, 400, and 700 cycles at 0° C. for electrolyte compositions containing 5, 10, and 20 vol. % F-DOL1 and the control electrolyte composition.

FIG. 23 shows Impedance (Ohms) (measured at 30° C.) before and after the 0° C. cycling shown in FIG. 22 for electrolyte compositions containing 5, 10, and 20 vol. % F-DOL1 and the control electrolyte composition.

### Cell Overview

A number of cells were prepared in order to test the performance of electrolyte compositions of the invention. The cells used were 4.3V NMC811/Gr 230 mAh pouch cells. The pouch cells were sourced from LiFun. The cathodes were single crystal LiNi_{0.8}Mn_{0.1}Co_{0.1}O₂ with an aluminium current collector. The anodes were artificial graphite with a copper current collector. Each pouch cell had a nominal cell capacity of 230 mAh and a loading of 2.2 mAh/cm². The pouch cells were dried at 60° C. under vacuum for several days. In an argon atmosphere glovebox, they were filled with 1 mL of electrolyte and sealed. After removal from the glovebox, the cells underwent a formation procedure at 45° C. followed by further electrochemical testing. The testing was done on a Maccor battery cycler. In the formation procedure, the cells were charged to 4.0V at a c-rate of C/50. The cells were removed from the testers, transferred into a glovebox, degassed and resealed. The formation procedure was completed with a C/10 charge to 4.3V, C/10 discharge to 2.75, and two more cycles between 4.3-2.75V, the second cycle at C/20 followed by the third cycle at C/5. These cells were used to test different electrolyte formulations.

Electrolyte preparation and storage was carried out in an argon atmosphere glove box (H₂O<10 ppm and O₂<2 ppm) using battery grade materials.

A control electrolyte formulation comprised ethyl carbonate/diethyl carbonate/ethyl methyl carbonate in a 1:1:1 ratio by volume, 1% by volume vinylene carbonate, and 1M LiPF₆. Unless otherwise stated, this composition was used as a control electrolyte in cells in the following examples, with examples of the invention including one or more further additives in the amount described.

An example electrolyte formulation comprised ethyl carbonate/diethyl carbonate/ethyl methyl carbonate in a 1:1:1 ratio by volume, 1% by volume vinylene carbonate, 1M LiPF₆, and 20% by volume 2-trifluoromethyl-1,3-dioxolane (“F-DOL1”).

Further example electrolyte formulations comprised ethyl carbonate/diethyl carbonate/ethyl methyl carbonate in a 1:1:1 ratio by volume, 1% by volume vinylene carbonate, 1M LiPF₆, and 2%, 5%, or 10% by volume 2-trifluoromethyl-1,3-dioxolane (“F-DOL1”) respectively.

A further example electrolyte formulation comprised ethyl carbonate/diethyl carbonate/ethyl methyl carbonate in a 1:1:1 ratio by volume, 1% by volume vinylene carbonate, 1M LiPF₆, and 20% by volume 2-difluoromethyl-1,3-dioxolane (“F-DOL2”) respectively.

### EXAMPLES

In the following examples, a range of electrolytes were tested in a cell as described in the cell overview above.

### Example 1—Fast Charge Cycling with 2-trifluoromethyl-1,3-dioxalane (“F-DOL1”)

Electrolyte preparation and storage was carried out in an Argon-filled glove box (H₂O<10 ppm and O₂<2 ppm). The base electrolyte was 1M LiPF₆ in ethylene carbonate:diethyl carbonate:ethyl methyl carbonate (1:1:1 vol. %) with vinylene carbonate added at 1 vol. %. 2-trifluoromethyl-1,3-dioxolane (F-DOL1) was added at concentrations of 2, 5, 10, and 20 vol. %. A control electrolyte was also prepared consisting of the base electrolyte alone.

The performance of each electrolyte formulation was tested in 4.3V NMC811/Gr pouch cells. The cells were made comprising a graphite anode with a copper current collector and a lithium nickel manganese cobalt oxide cathode with an aluminium current collector. After formation, the pouch cells were put in a 30° C. oven and cycled on a Maccor battery cycler for 470 cycles with a 4C charge rate and C/2 discharge rate between 4.3-2.75V.

### Cycling Stability

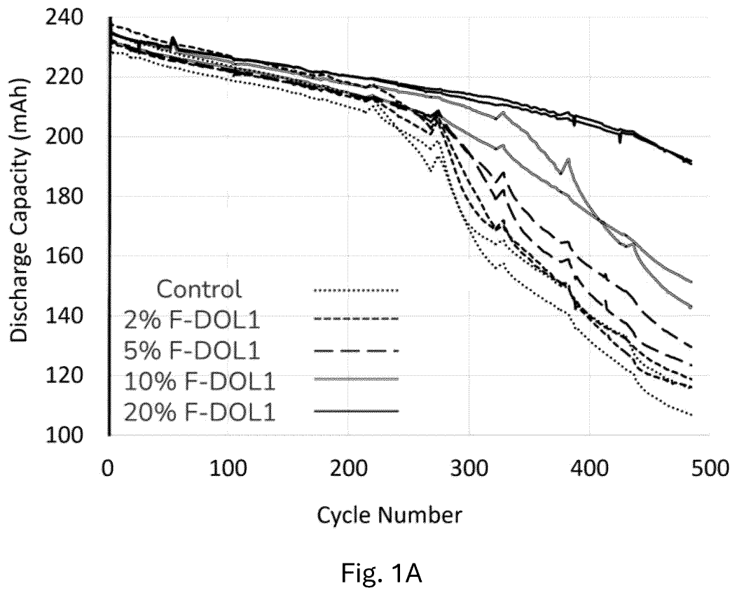

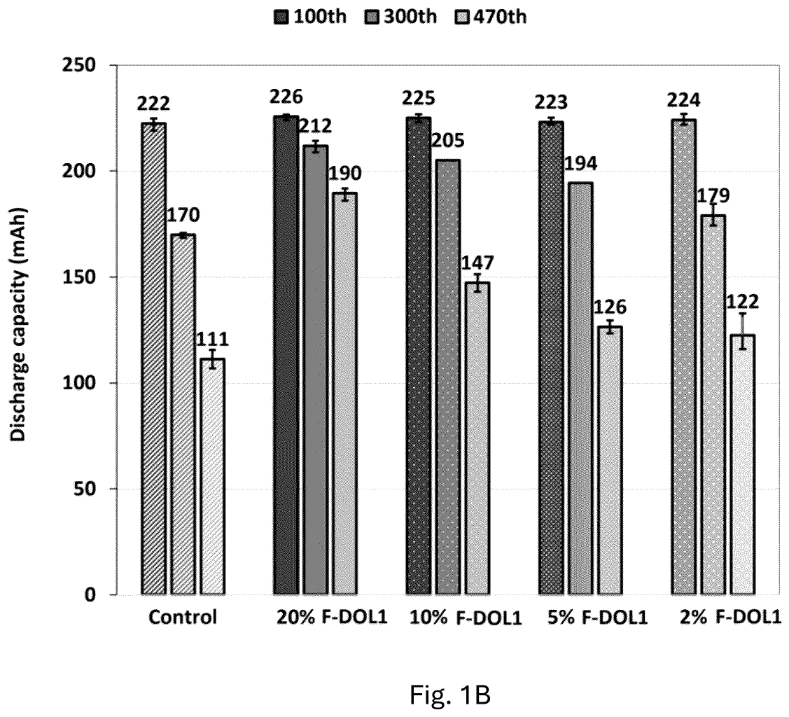

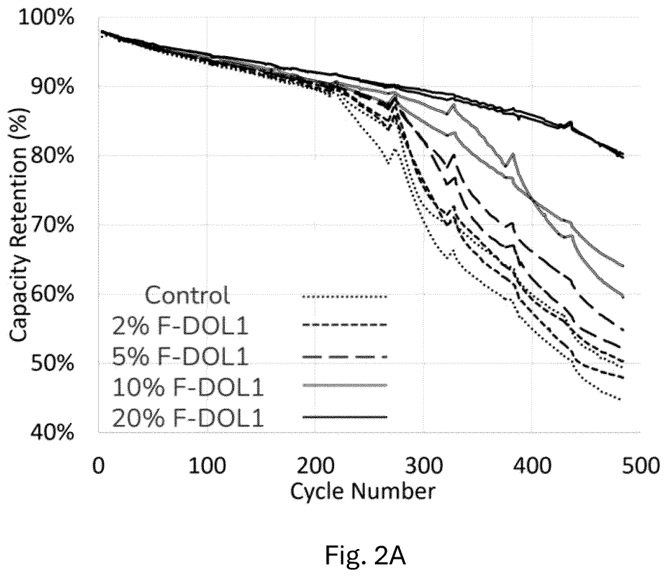

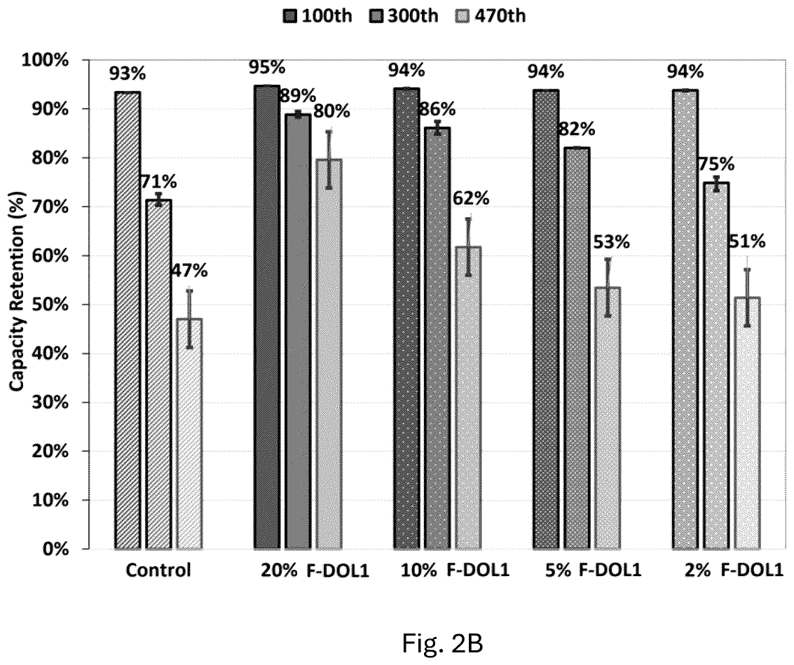

The discharge capacity and percent capacity retention of the cells were measured across 470 cycles of 4C charge cycling at 30° C. The results are shown in FIGS. 1A and 1B and FIGS. 2A and 2B.

After 300 cycles, the capacity retention of the control electrolyte formulation dropped to about 70%, whereas the capacity retention of the formulations comprising 5, 10 and vol. % F-DOL1 dropped to between 80 and 90%. Furthermore, after the last cycle, the capacity retention of the control electrolyte formulation had dropped to 47% compared to 80% in the 20 vol. % F-DOL1 formulation.

Similarly, the discharge capacity of the control electrolyte formulation dropped to around 170 mAh after 300 cycles, and to 111 mAh after the last cycle. The discharge capacity of the 5, 10 and 20 vol. % F-DOL1 formulations however dropped to between 200 and 210 mAh after 300 cycles, and in the 20 vol. % F-DOL1 formulation only dropped to 190 mAh after the last cycle.

These electrochemical test results show that the cycling capacity of the cells was positively influenced by F-DOL1 in concentrations of 5 to 20 vol. %, particularly in concentrations of 20 vol. %.

### Impedance

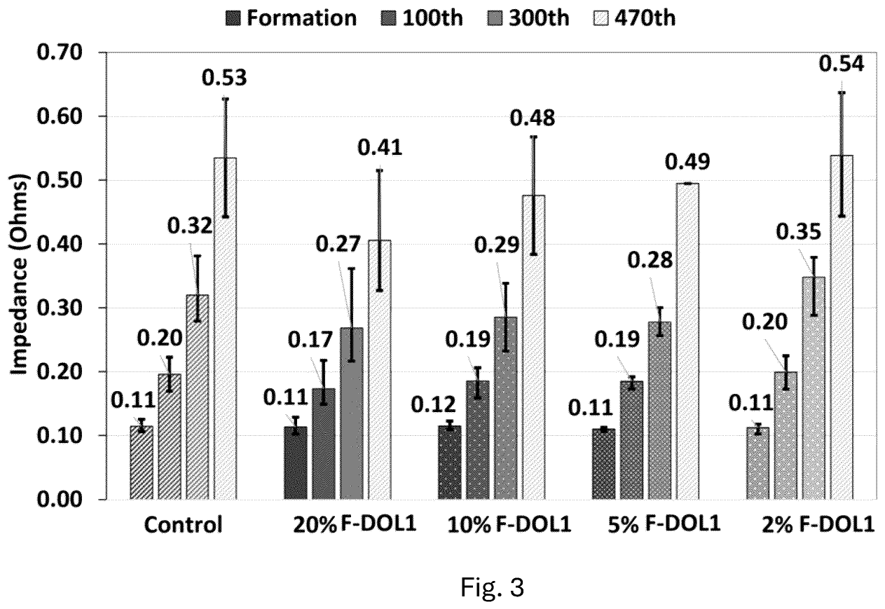

The impedance of the cells was measured across 470 cycles of 4C charge cycling at 30° C. The results are shown in FIG. 3.

Impedance measurements were performed on a Biologic potentiostat with all pouch cells at 3.7-3.8V and 30° C. The electrochemical impedance spectroscopy was performed from 1 MHz to 10 mHz with a voltage amplitude of 10 mV.

After 300 cycles, the impedance of the control electrolyte formulation was 0.32 Ohms, compared to an average impedance, taken across three cells, of 0.27, 0.29, and 0.28 Ohms with the 20, 10, and 5 vol. % F-DOL1 formulations, respectively. After 470 cycles, the impedance of the control electrolyte formulation was 0.53 Ohms, whereas the impedance of the 20 vol. % F-DOL1 formulation was only 0.41.

These electrochemical test results show that the impedance of the cells was positively influenced by F-DOL1 in concentrations of 5 to 20 vol. %, particularly in concentrations of 20 vol. %.

### Gassing

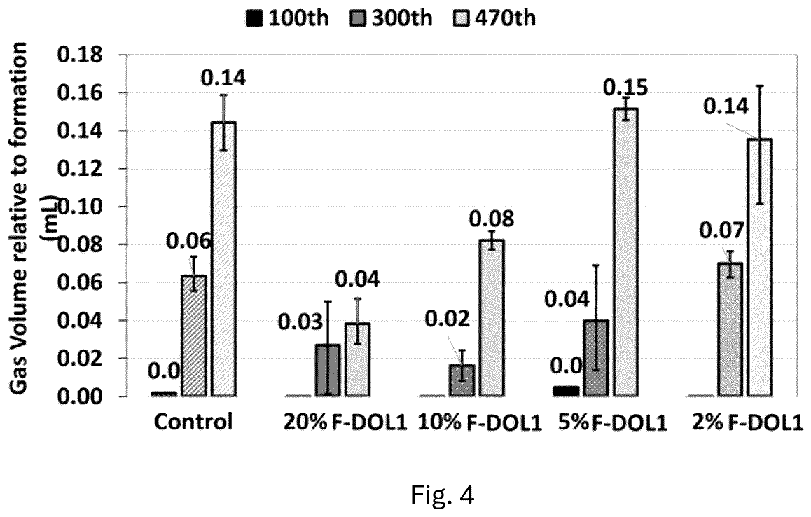

The gassing of the cells was measured across 470 cycles of 4C charge cycling at 30° C. The results are shown in FIG. 4.

The gassing was measured based on the change in cell volume. The volume of the Li-ion cell is determined using the Archimedes technique with an analytical balance that is fitted with a custom density Archimedes kit. The mass of the Li-ion cell in air is measured. The cell is then submerged in water and the mass of the cell is measured again. The difference between the mass in air and apparent mass in the water represents the mass of water displaced by the Li-ion cell. The volume of water displaced by the Li-ion cell is calculated from the mass of water displaced using the density of the water at the temperature tested. The Archimedes principle indicates that an object fully submerged in a liquid will displace a volume of liquid equal to the volume of the object.

After 300 cycles, the cells with electrolyte formulation with 10 vol. % F-DOL1 demonstrated the least gassing on average, with the electrolyte formulation with 20 vol. % F-DOL1 also showing reduced gassing compared to the control formulation.

After 470 cycles, both the 10 and 20 vol. % F-DOL1 formulations still showed reduced gassing compared to the control formulation.

These electrochemical test results show that the gassing of the cells was positively influenced by F-DOL1 in concentrations of 10 to 20 vol. %. Gassing generally indicates a decomposition of the electrolyte, thus this indicates that F-DOL1 delivers improved stability to an electrolyte.

### Lithium Plating

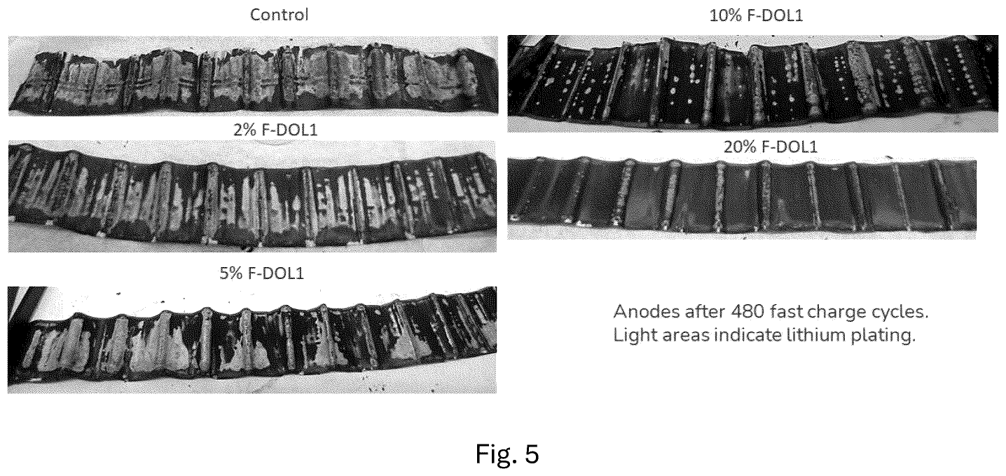

The lithium plating of the anodes was photographically assessed after 470 cycles of 4C charge cycling at 30° C. The results are shown in FIG. 5.

After 470 cycles, there was significantly less lithium plating found with the electrolyte formulations comprising 5, 10 and 20 wt. % F-DOL1 compared to the control formulation.

These electrochemical test results show that the lithium plating of the anodes was positively influenced by F-DOL1 in concentrations of 5 to 20 vol %. Lithium plating of an anode generally results in the decreased cell capacity and can also lead to decreased thermal safety. Thus these results show that the inclusion of F-DOL1 in an electrolyte will positively impact these factors.

### ICP of Anodes

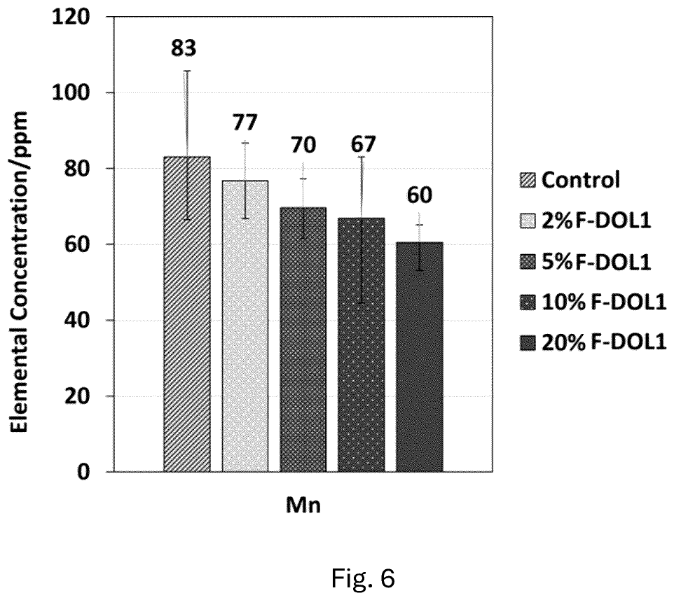

After the low temperature rate test and high temperature cycling, ICP of the anodes was carried out to determine their metal content. The results are shown in FIG. 6.

Transition metal content on the anode was measured after testing by extracting the anodes and scraping the anode coating from the current collector. The anode coating was placed into a vial with 10 mL nitric acid and digested overnight. The samples were run in an Agilent 5110 ICP-OES to measure elemental concentrations of transition metals. Calibration standards were also run containing the elements of interest to enable quantification.

The anodes of the cell containing the control electrolyte were found to contain 83 ppm manganese. The anodes of the cell containing the 20 vol. % F-DOL1 formulation were found to contain 60 ppm manganese.

These results show that less manganese has been transported from the cathode to the anode in the cell containing 20 vol. % F-DOL1 formulation. This shows that manganese dissolution has been reduced by the addition of F-DOL1 to the electrolyte formulation.

### Example 2—Wide Temperature Test: 0° C. Rate Test Followed by High Temperature Cycling with F-DOL1

Electrolyte preparation and storage was carried out in an Argon-filled glove box (H₂O<10 ppm and O₂<2 ppm). The base electrolyte was 1M LiPF₆ in ethylene carbonate:diethyl carbonate:ethyl methyl carbonate (1:1:1 vol. %) with vinylene carbonate added at 1 vol. %. 2-trifluoromethyl-1,3-dioxolane (F-DOL1) was added at a concentration of 20 vol. %. A control electrolyte was also prepared consisting of the base electrolyte alone.

The cells were made comprising a graphite anode with a copper current collector, a lithium nickel manganese cobalt oxide cathode with an aluminium current collector. After undergoing the 45° C. formation procedure described earlier, the cells were tested on a Maccor battery cycler in a Tenney variable temperature oven. The cells were cycled between 4.3-2.75V using a 0° C. rate test beginning with 10 cycles at 30° C. with a charge rate of C/2 and a discharge rate of C/2, followed by changing the oven temperature to 0° C. (equilibrating at 0° C. for two hours) and cycling for 3 cycles at C/2 charge rate and C/2 discharge rate, 3 cycles at C/2 charge rate and 1C discharge rate, 3 cycles at C/2 charge rate and 2C discharge rate, and 3 cycles at C/2 charge rate and C/2 discharge rate, after which the oven temperature was changed back to 30° C. (equilibrated at 30° C. for two hours) and the cells were cycled for 10 cycles at C/2 charge rate and C/2 discharge rate. After this 0° C. rate test, the pouch cells were put in a 45° C. oven and cycled on the Maccor battery cycler for 300 cycles with a C/2 charge and discharge rate between 4.3-2.75V. Every 100 cycles the cells were paused and removed from the oven and Maccor cycler for gas volume measurements by the Archimedes method and impedance measurements on a Biologic potentiostat.

### 0° C. Rate Capability

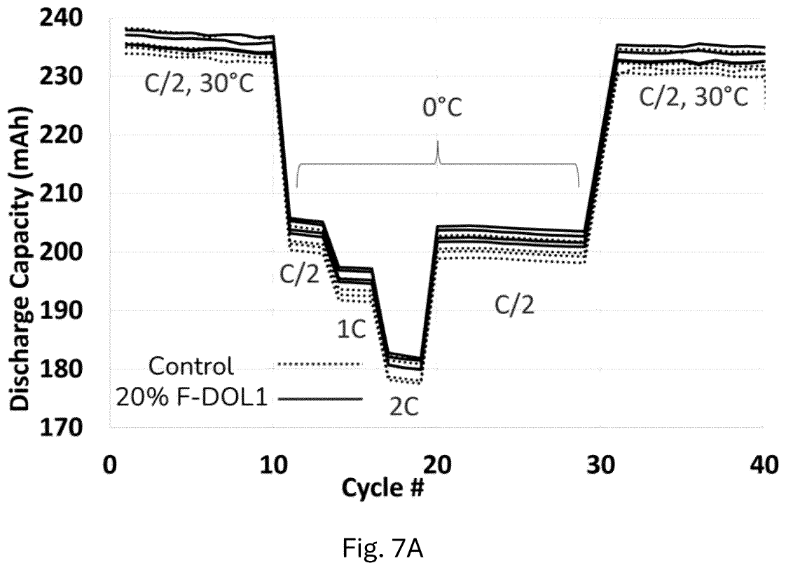

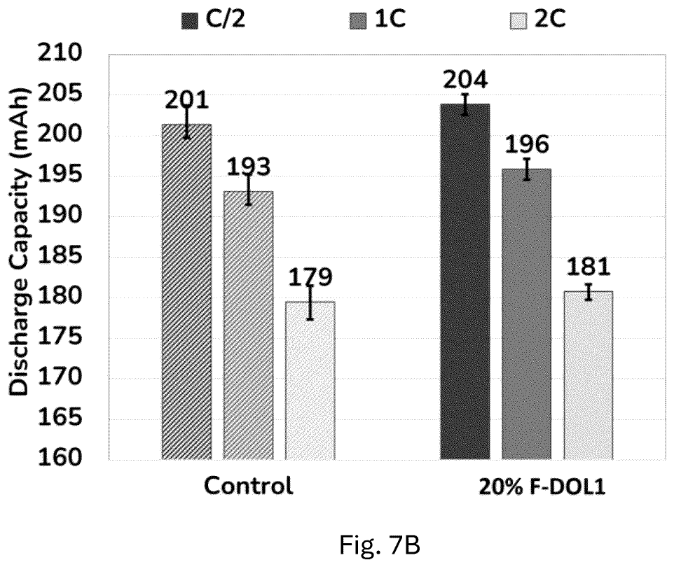

The discharge capacity of the cells was measured during discharging at C/2, 1C, and 2C rates at 0° C. The results are shown in FIGS. 7A and 7B.

The results show improved average capacities at C/2, 1C and 2C rates with the 20 vol. % formulation over the control electrolyte formulation across four replicate cells for each formulation.

These electrochemical test results show that the cycling capacity of the cells was slightly improved by F-DOL1 in concentrations of 20 vol. % during high rate discharge at low temperature.

### High Temperature Cycling Stability

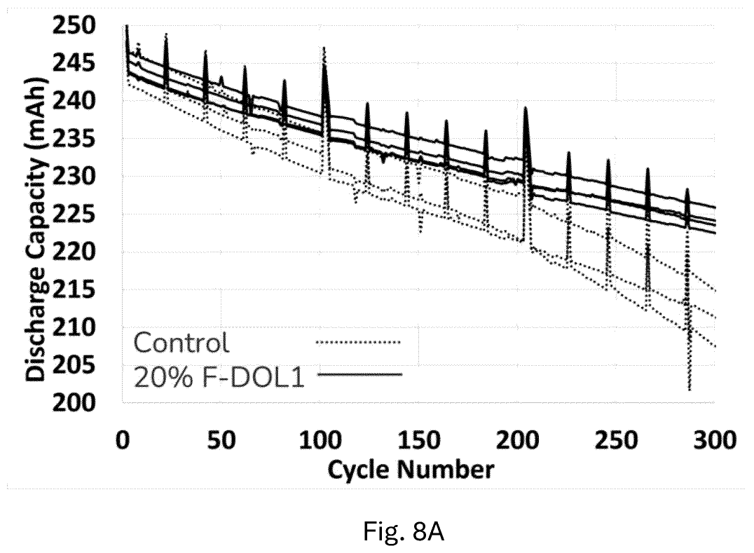

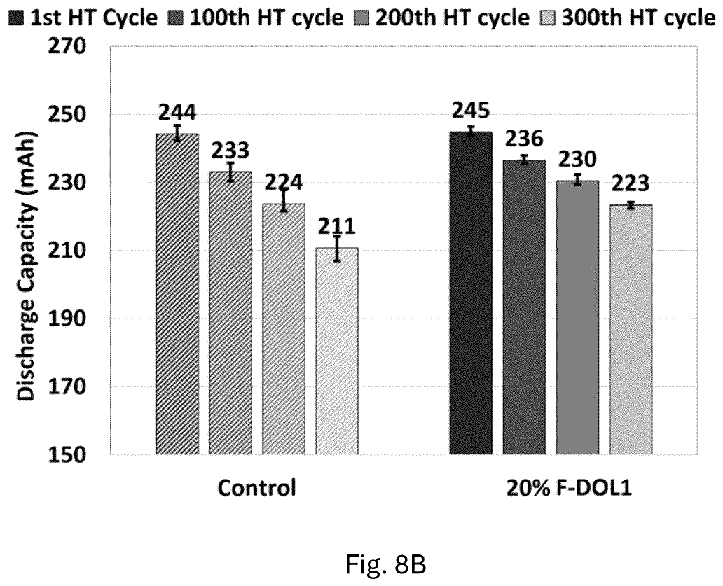

The discharge capacity of the cells was measured across 300 cycles of high temperature cycling at 45° C. The results are shown in FIGS. 8A and 8B.

After 300 cycles, the control electrolyte formulation exhibited a discharge capacity of 211 mAh compared to the superior discharge capacity of the 20 vol. % F-DOL1 formulation at 223 mAh.

These electrochemical test results show that the high temperature cycling stability was improved by the addition of F-DOL1 to the electrolyte formulation.

### Impedance

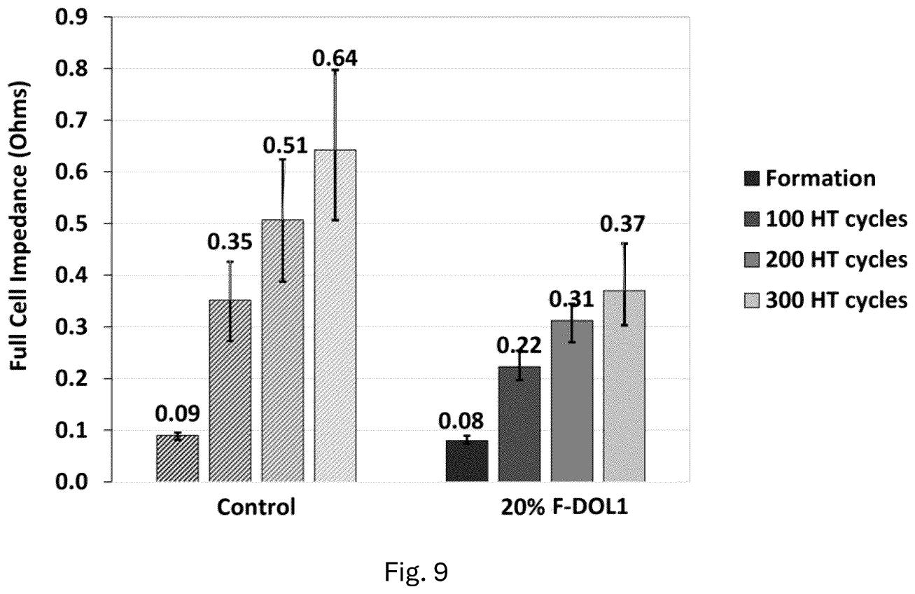

The impedance of the cells was measured as described above across 300 cycles of high temperature cycling at 45° C. The results are shown in FIG. 9.

After 300 cycles, the control electrolyte formulation exhibited impedance of 0.64 Ohms compared to the lower impedance of 0.37 Ohms in the 20 vol. % F-DOL1 formulation.

These electrochemical test results show that impedance was reduced by the addition of F-DOL1 to the electrolyte formulation.

### Gassing

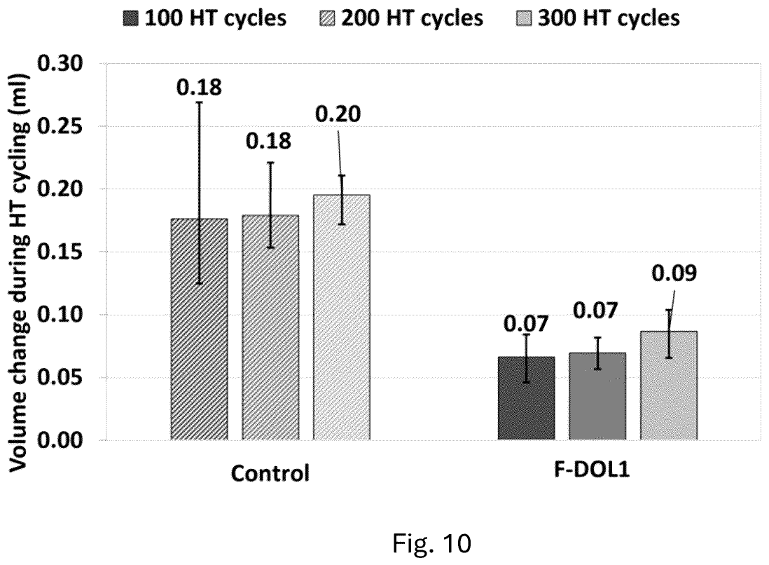

The gassing of the cells was measured as described above across 300 cycles of high temperature cycling at 45° C. The gassing of the cells was measured by using the Archimedes method to determine the change in gas volume. The results are shown in FIG. 10.

After 300 cycles, the control electrolyte formulation exhibited a 0.2 mL volume change compared to the lower volume change of 0.09 mL in the 20 vol. % F-DOL1 formulation.

These electrochemical test results show gassing was reduced by the addition of F-DOL1 to the electrolyte formulation.

### ICP of Anodes

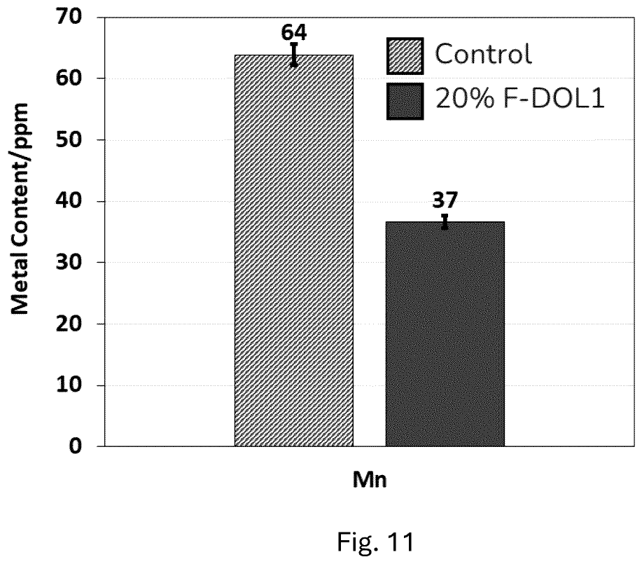

After the low temperature rate test and high temperature cycling, ICP of the anodes was carried out as described above to determine their metal content. The results are shown in FIG. 11.

The anodes of the cell containing the control electrolyte were found to contain 64 ppm manganese. The anodes of the cell containing the 20 vol. % F-DOL1 formulation were found to contain 37 ppm manganese.

These results show that less manganese has been transported from the cathode to the anode in the cell containing 20 vol. % F-DOL1 formulation. This shows that manganese dissolution has been reduced by the addition of F-DOL1 to the electrolyte formulation.

### XPS Depth Profiling

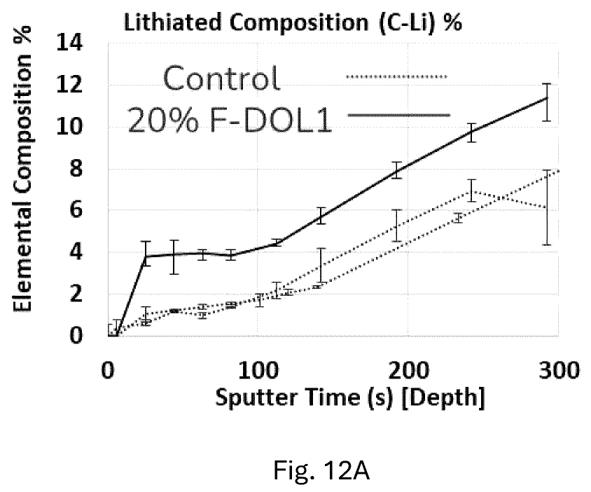

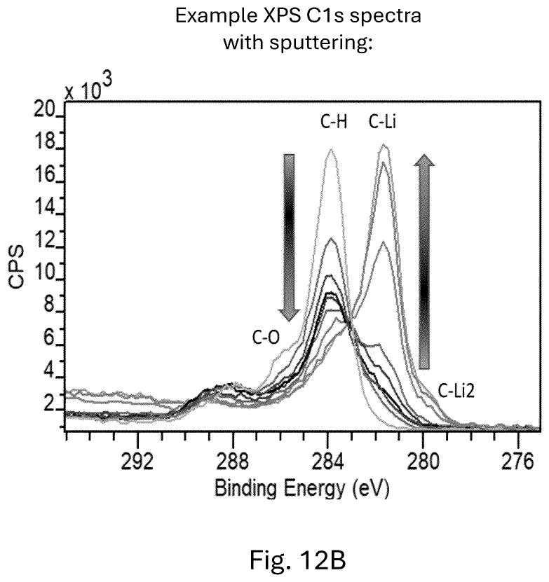

After the low temperature rate test and high temperature cycling, XPS depth profiling of the anodes was carried out to determine the thickness of their SEI (solid electrolyte interphase). The results are shown in FIGS. 12A and 12B.

Anode samples were prepared for XPS analysis in an Argon glovebox and loaded into an air-free sample holder on insulating tape. The holder was transported to a Thermo K-Alpha XPS and the samples were loaded without exposure to air. Depth profiling was performed using monatomic argon sputtering at 3000 eV. All analysis was performed with the ion gun on. The spectra were aligned to LiF at 685 eV and peaks were fit with Gaussian/Lorentzian 50/50 or 70/30 line shapes, constraining the full width half maximum to a maximum of 1.9 eV. The lithiated graphite composition was calculated as the C1s area percent of the Cli peak fit within the 282-284 eV region of the C1s scan, multiplied by the elemental area percent of the C1s peak from the survey scan. Surveys were collected 0-850 eV with 5 scans, 50 ms dwell time, 200 eV pass energy and 0.2 eV step size. C1s scans were collected 279-298 eV and F1s scans were collected with 678-698 eV, both with 50 ms dwell time, 50 eV pass energy, and 0.2 eV step size.

These results show that the addition of F-DOL1 to the electrolyte formulation results in a thinner SEI on the anode. Thinner SEI on the anode correlates with improved high-temperature cycling capacity.

### Example 3—High Temperature Cycling with F-DOL1

Electrolyte preparation and storage was carried out in an Argon-filled glove box (H₂O<10 ppm and O₂<2 ppm). The base electrolyte was 1M LiPF₆ in ethylene carbonate:diethyl carbonate:ethyl methyl carbonate (1:1:1 vol. %) with vinylene carbonate added at 1 vol. %. 2-trifluoromethyl-1,3-dioxolane (F-DOL1) was added at concentrations of 2, 5, 10 and 20 vol. %. A control electrolyte was also prepared consisting of the base electrolyte alone.

The performance of each electrolyte was tested in multi-layer LiFun 2022 4.3V NMC811/Gr Pouch Cells. The cells were made comprising a graphite anode with a copper current collector, a lithium nickel manganese cobalt oxide cathode with an aluminium current collector, and a polyethylene membrane. After formation, the pouch cells were put in a 30° C. oven and cycled on a Maccor battery cycler for 30 cycles then put in a 45° C. oven and cycled on a Maccor battery cycler for 700 cycles with a C/2 charge and discharge rate between 4.3-2.75V. Every 100 cycles the cells were paused and removed from the oven and Maccor cycler for gas volume measurements by the Archimedes method and impedance measurements on a Biologic potentiostat.

### Cycling Stability

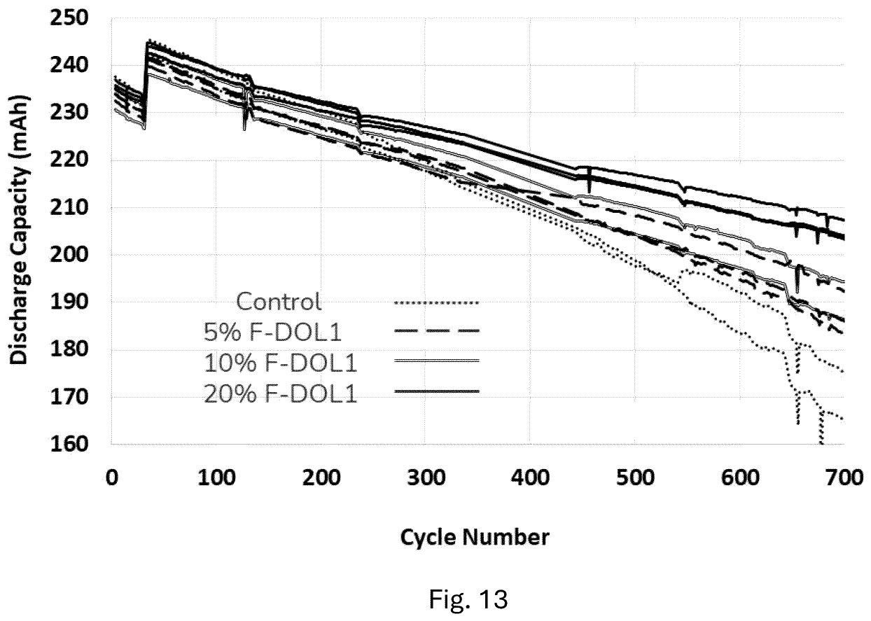

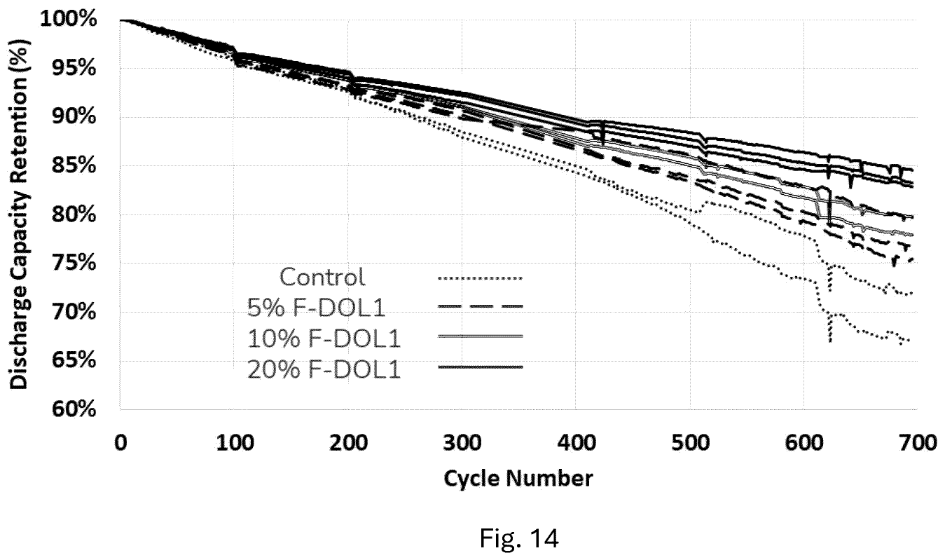

The discharge capacity of the cells was measured across 30 cycles at 30° C. and a subsequent 700 cycles at 45° C. The results are shown in FIGS. 13 and 14.

After the last cycle, the discharge capacity of the control electrolyte formulation dropped by more than the formulation comprising 20 vol. % F-DOL1.

These electrochemical test results show that the cycling capacity of the cells was positively influenced by F-DOL1 in concentrations of 20 vol. %.

### Impedance

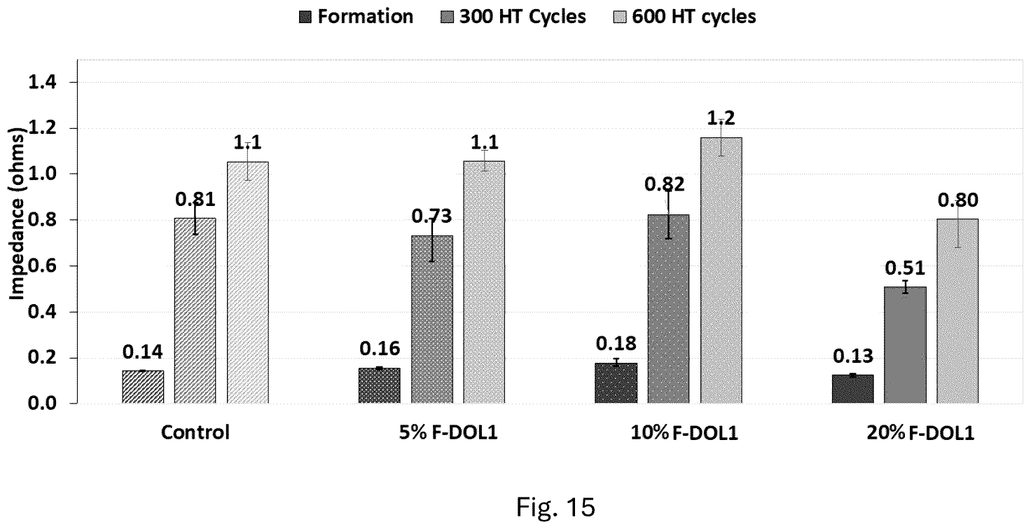

The impedance of the cells was measured as described above after formation as well as after 300 and 600 cycles at 45° C. The results are shown in FIG. 15.

After the 300 high temperature cycles, the impedance of the control electrolyte was 0.81 Ohms, compared to 0.51 Ohms with the 20 vol. % F-DOL1 formulations. After 600 cycles, the impedance of the control electrolyte formulation was 1.1 Ohms, whereas the impedance of the 20 vol. % F-DOL1 formulation was only 0.80 Ohms.

These electrochemical test results show that the impedance of the cells was positively influenced by F-DOL1 in the concentration of 20 vol. % during HT cycling.

### Gassing

The gassing of the cells was measured as described above after 300 and 600 cycles at 45° C. Volume measurements were taken as the increase in volume after aging, relative to the cell volume after formation. The results are shown in FIG. 16.

After 600 cycles, the electrolyte formulations with 5, 10 and 20 vol. % F-DOL1 exhibited an increase in cell volume of 0.19, 0.10, and 0.13 mL, respectively, compared with an increase in cell volume of 0.32 mL in the control.

These electrochemical test results show that the gassing of the cells was positively influenced by F-DOL1 in concentrations of 5 to 20 vol. %.

### Example 4—High Temperature Cycling with 2-Difluoromethyl-1,3-Dioxalane (“F-DOL2”)

Electrolyte preparation and storage was carried out in an Argon-filled glove box (H₂O<10 ppm and O₂<2 ppm). The base electrolyte was 1M LiPF₆ in ethylene carbonate:diethyl carbonate:ethyl methyl carbonate (1:1:1 vol. %) with vinylene carbonate added at 1 vol. %. 2-difluoromethyl-1,3-dioxolane (F-DOL2) was added at a concentration of 20 vol. %. A control electrolyte was also prepared consisting of the base electrolyte alone.

The performance of each electrolyte formulation was tested in 4.3V NMC811/Gr Pouch Cells. The cells were made comprising a graphite anode with a copper current collector, a lithium nickel manganese cobalt oxide cathode with an aluminium current collector, and a polyethylene membrane. After formation, the pouch cells were put in a 45° C. oven and cycled on a Novonix battery cycler for 400 cycles with a C/2 charge and discharge rate between 4.3-2.75V.

### Discharge Capacity

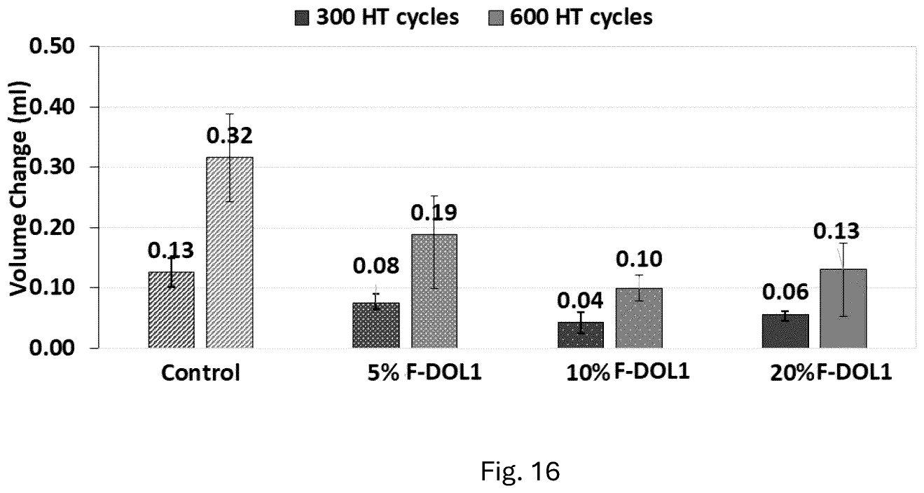

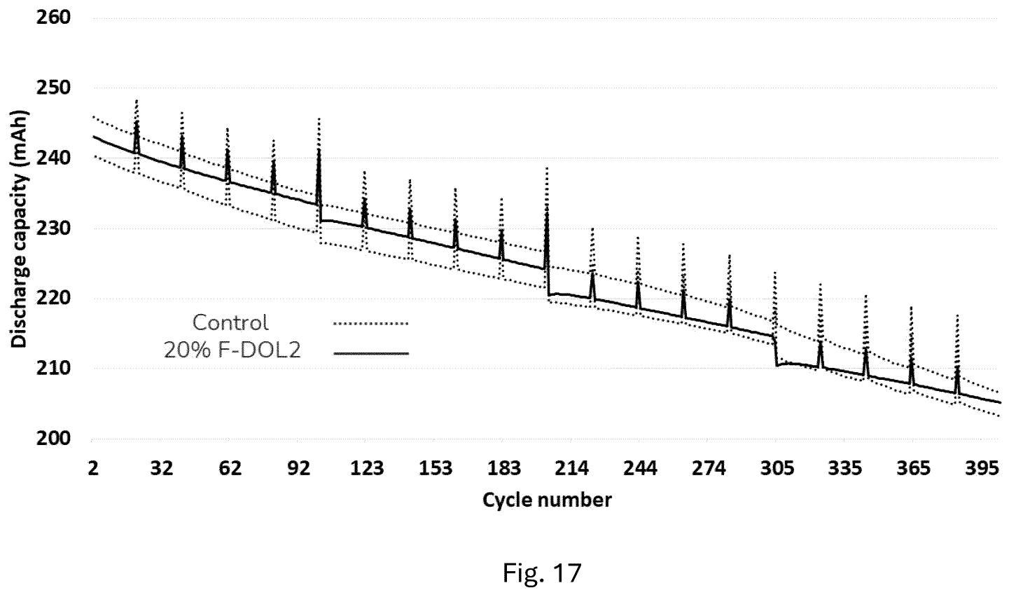

The discharge capacity of the cells was measured across 400 cycles of 45° C. cycling at with C/2 c-rate charge and discharge. The results are shown in FIG. 17.

After 400 cycles, the discharge capacity of the control electrolyte formulation dropped to between 200 to 210 mAh. The discharge capacity of the 20 vol. % F-DOL2 formulation dropped to a similar level.

These electrochemical test results show that the cycling capacity of the cells was not negatively affected by F-DOL2 in concentrations of 20 vol. %.

### Gassing

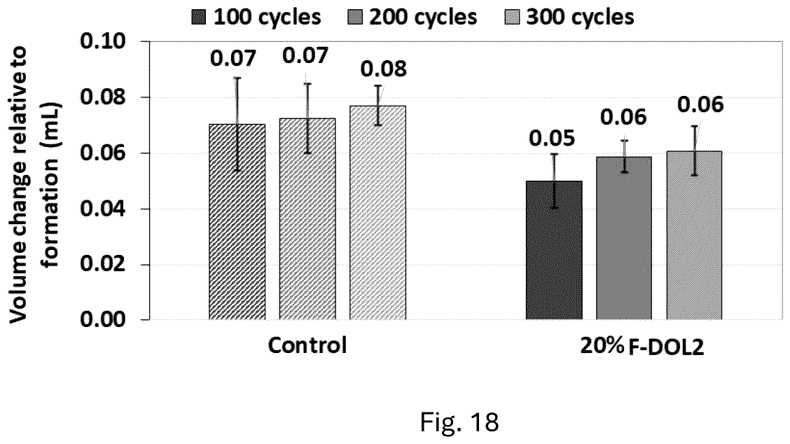

The gassing of the cells was measured as described above across 300 cycles of 45° C. cycling. The results are shown in FIG. 18.

After 300 cycles, the cells with electrolyte formulation with 20 vol. % F-DOL2 demonstrated a lower change in volume on average (0.06 mL) compared to the control formulation (0.08 mL). This shows that there has been less gassing in the cells containing the electrolyte formulation with 20 vol. % F-DOL2.

These electrochemical test results show that the gassing of the cells was positively influenced by F-DOL2 in a concentration of 20 vol. %. Gassing generally indicates a decomposition of the electrolyte, thus this indicates that F-DOL2 delivers improved stability to the baseline electrolyte.

### Example 7—Low Temperature Rate and 0° C. Cycling and F-DOL1

Electrolyte preparation and storage was carried out in an Argon-filled glove box (H₂O<10 ppm and O₂<2 ppm). The base electrolyte was 1M LiPF₆ in ethylene carbonate:diethyl carbonate:ethyl methyl carbonate (1:1:1 vol. %) with vinylene carbonate added at 1 vol. %. 2-trifluoromethyl-1,3-dioxolane (F-DOL1) was added at concentrations of 5, 10 and 20 vol. %. A control electrolyte was also prepared consisting of the base electrolyte alone.

The performance of each electrolyte was tested in multi-layer LiFun 4.3V NMC811/Gr Pouch Cells over in sequential rate tests at 0° C., −10° C., and −20° C. followed by C/2 cycling at 0° C. The cells were made comprising a graphite anode with a copper current collector, a lithium nickel manganese cobalt oxide cathode with an aluminium current collector.

### Discharge Capacity

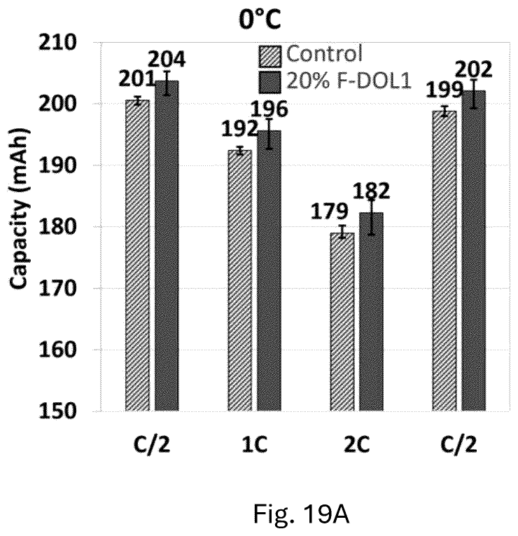

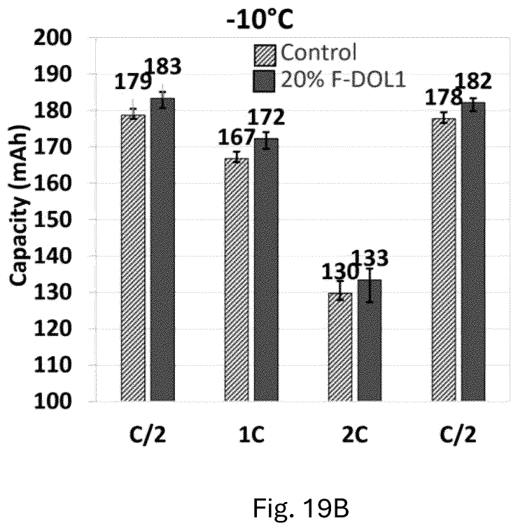

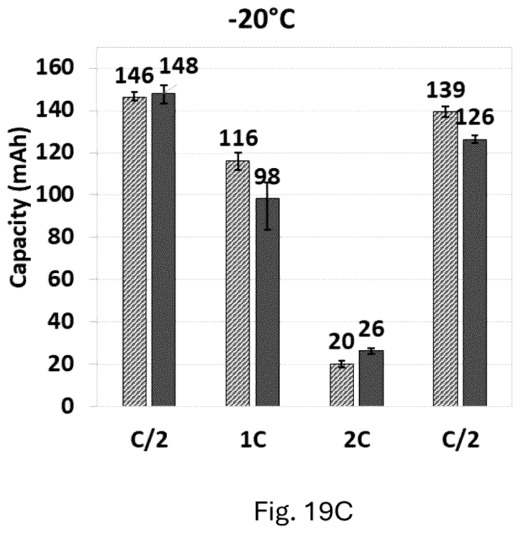

The discharge capacities of the 20 vol. % F-DOL1 and control cells were measured at 0° C. during a rate test with 3 cycles charged at C/2 and discharged at C/2 followed by 3 cycles charged at C/2 and discharged at 1C followed by 3 cycles charged at C/2 and and 2C followed by 3 cycles charged at C/2 and discharged at C/2. The results are shown in FIG. 19A. After the rate test at 0° C., the same rate test was performed at −10° C. (see FIG. 19B), followed by the same rate test at −20° C. (see FIG. 19C).

The results show improved capacities at C/2, 1C and 2C rates with the 20 vol. % formulation over the control electrolyte formulation at 0° C. and −10° C. The discharge capacity of the 20 vol. % F-DOL1 formulation was also superior to that of the control electrolyte formulation at −20° C. at the 2C rate.

These electrochemical test results show that the cycling capacity of the cells was improved by F-DOL1 in concentrations of 20 vol. %, at least at 0° C. and −10° C., and partially at −20° C.

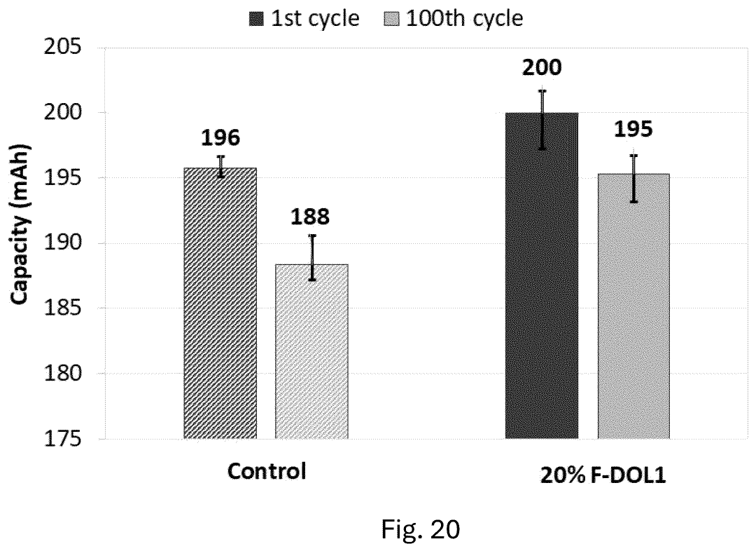

After the low temperature rate tests, the discharge capacities of the 20 vol. % F-DOL1 and control cells were measured across 100 cycles of C/2 charge cycling at 0° C. The results are shown in FIG. 20 for the first cycle and the 100^{th} cycle.

After 100 cycles, the discharge capacity of the control formulation had dropped to 188 mAh compared to 195 mAh with the 20 vol. % F-DOL1 formulation. Again, see FIG. 20.

These electrochemical test results show that the cycling capacity of the cells was improved by F-DOL1 in a concentration of 20 vol. %, even at low temperatures.

### Impedance

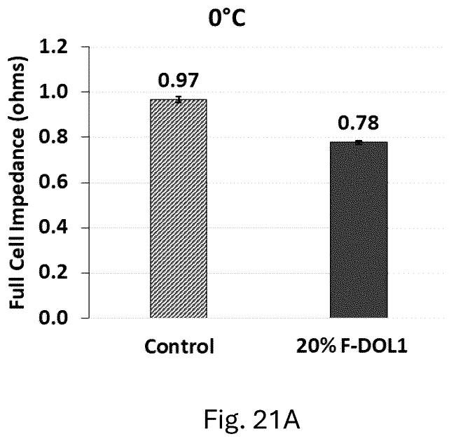

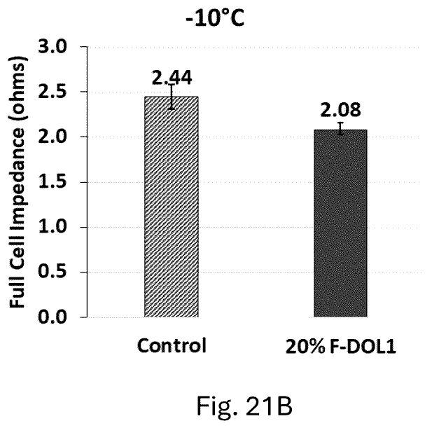

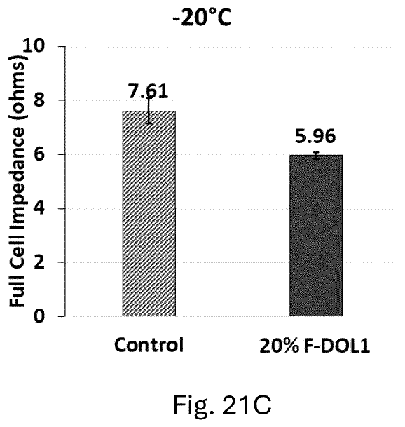

The impedance of the cells was measured as described above after the 0° C., −10° C., and −20° C. rate tests followed by 100 cycles at 0° C. The results are shown in FIG. 21A (0° C.), FIG. 21B (−10° C.) and FIG. 21C (−20° C.).

The impedance of the control electrolyte formulation at 0° C. was 0.97 ohms compared to an impedance of 0.78 ohms with the 20 vol. % F-DOL1 formulation. The impedance of the control electrolyte formulation at −10° C. was 2.44 ohms compared to an impedance of 2.08 ohms with the 20 vol. % F-DOL1 formulation. The impedance of the control electrolyte formulation at −20° C. was 7.61 ohms compared to an impedance of 5.96 ohms with the 20 vol. % F-DOL1 formulation.

These electrochemical test results show that the impedance of the cells was positively influenced by F-DOL1 in concentrations of 20 vol. %, even at low temperatures.

### Example 8 −0° C. Cycling and F-DOL1

Electrolyte preparation and storage was carried out in an Argon-filled glove box (H₂O<10 ppm and O₂<2 ppm). The base electrolyte was 1M LiPF₆ in ethylene carbonate:diethyl carbonate:ethyl methyl carbonate (1:1:1 vol. %) with vinylene carbonate added at 1 vol. %. 2-difluoromethyl-1,3-dioxolane (F-DOL2) was added at a concentration of 5, 10, and 20 vol. %. A control electrolyte was also prepared consisting of the base electrolyte alone.

The performance of each electrolyte formulation was tested in 4.3V NMC811/Gr Pouch Cells. The cells were made comprising a graphite anode with a copper current collector, a lithium nickel manganese cobalt oxide cathode with an aluminium current collector, and a polyethylene membrane. After formation, the pouch cells were put in a 0° C. oven and cycled on a Maccor battery cycler for 700 cycles with a C/2 charge and discharge rate between 4.3-2.75V.

### Discharge Capacity

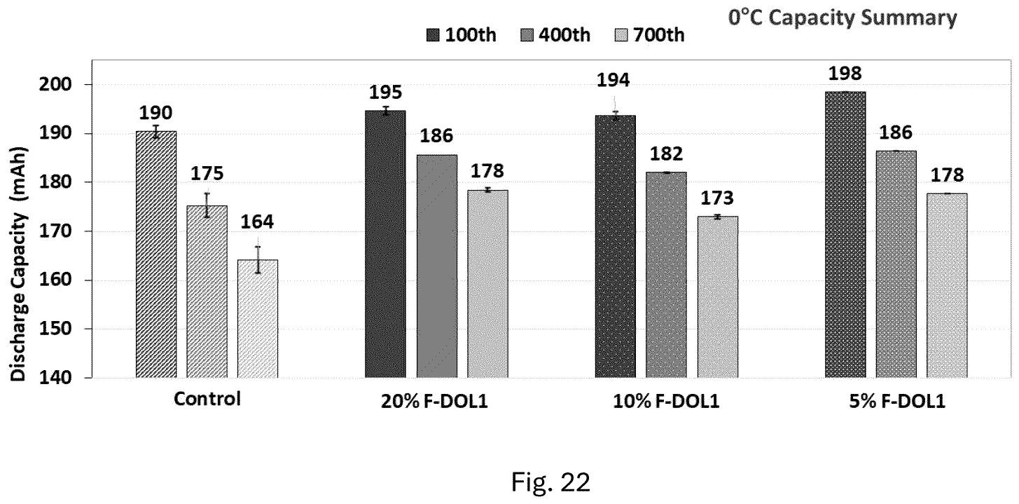

The discharge capacity of the cells were measured across 700 cycles of 0° C. cycling at with C/2 c-rate charge and discharge. The results are shown in FIG. 22A (which shows discharge capacity after the 100^{th}, 400^{th}, and 700^{th} cycles).

After 700 cycles, the discharge capacity of the control formulation had dropped to 164 mAh compared to 178 mAh with the 20 vol. % F-DOL1 formulation, 173 mAh with the 10% F-DOL1 formulation, and 178 mAh with the 5 vol. % F-DOL1 formulation.

These electrochemical test results show that the cycling capacity of the cells was improved by F-DOL1 in concentrations of 5-20 vol. %, even at low temperatures.

### Impedance

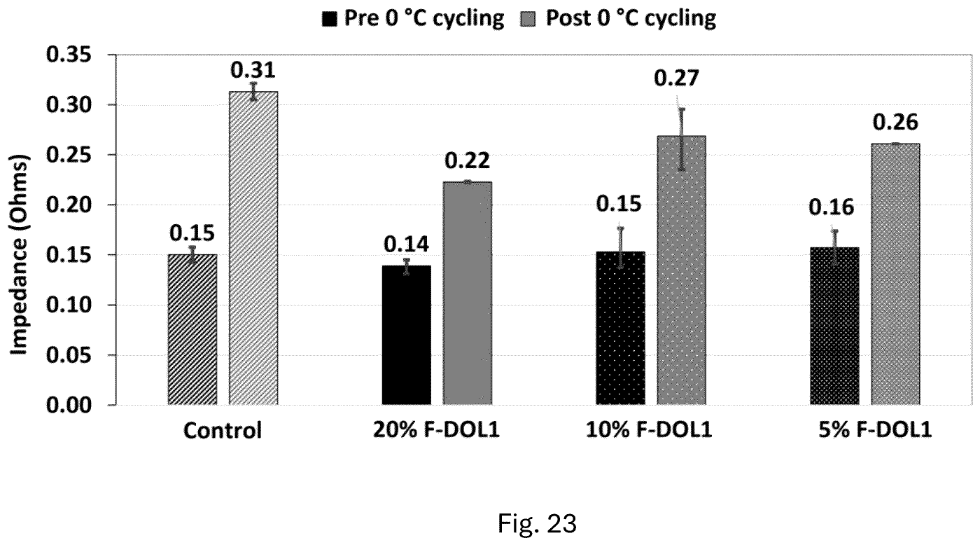

The impedance of the cells was measured as described above before and after 700 cycles at 0° C. The results are shown in FIG. 23.

The impedance of the control electrolyte formulation after 0° C. cycling was 0.31 ohms compared to an impedance of 0.22 ohms with the 20 vol. % F-DOL1 formulation. The impedance of the 5 vol. % F-DOL1 formulation after 0° C. cycling was 0.27 ohms and the impedance of the 10 vol. % F-DOL1 formulation after 0° C. cycling was 0.26 ohms.

These electrochemical test results show that the impedance of the cells was positively influenced by F-DOL1 in concentrations of 5-20 vol. %, even at low temperatures.

The electrolyte formulations disclosed herein therefore allow fast charging and maintain a consistent discharge and capacity through a large number of cycles even when deployed in many different temperature conditions whilst also maintaining high temperature cycling stability.

This is achieved through the presence of compounds of Formula 1 or Formula 2 in an amount of 1 to 30% by weight of the liquid component of the battery electrolyte formulation which has been shown in the examples above to reduce lithium plating, reduce gassing, and reduce impedance.

1. A battery electrolyte formulation comprising:
a charge carrying species;
one or more solvents; and a compound of Formula 1: 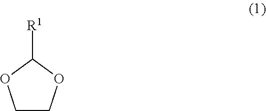
wherein R¹ is a fluorinated methyl group,
wherein the compound of Formula 1 is present in an amount of about 1 to about 30% by weight of liquid components of the battery electrolyte formulation.

2. The formulation of claim 1, wherein R¹ is CHF₂ or CF₃.

3. The formulation of claim 1, wherein the compound of Formula 1 is present in an amount of about 2 to about 25% by weight of the liquid components of the battery electrolyte formulation.

4. The formulation of claim 1, wherein the compound of Formula 1 is present in an amount of about 6 to about 25% by weight of the liquid components of the battery electrolyte formulation.

5. The formulation of claim 1, wherein the compound of Formula 1 is present in an amount of about 12 to about 25% by weight of the liquid components of the battery electrolyte formulation.

6. The formulation of claim 1, further comprising diethyl sulfone in an amount of less than 30% by weight of the liquid components of the battery electrolyte formulation.

7. The formulation of claim 1, wherein the charge carrying species comprises a metal electrolyte salt.

8. The formulation of claim 7, wherein the metal electrolyte salt is present in a concentration of about 0.1 to about 2M.

9. The formulation of claim 7, wherein the metal salt is a salt of lithium selected from the group comprising lithium hexafluorophosphate (LiPF₆), lithium perchlorate (LiClO₄), lithium tetrafluoroborate (LiBF₄), lithium triflate (LiSO₃CF₃), lithium bis(fluorosulphonyl)imide (Li(FSO₂)₂N), lithium bis(trifluoromethanesulphonyl)imide (Li(CF₃SO₂)₂N), and combinations thereof.

10. The formulation of claim 1, wherein at least one of the one or more solvents is selected from the group comprising ethylene carbonate (EC), diethyl carbonate (DEC), ethyl methyl carbonate (EMC), and mixtures thereof.

11. The formulation of claim 1, further comprising vinylene carbonate (VC).

12. The formulation of claim 1, which comprises less than 20% diethyl sulfone by weight of the battery electrolyte formulation.

13. The formulation of claim 1, which is substantially free from diethyl sulfone.

14. A battery electrolyte formulation comprising:
a charge carrying species;
one or more solvents; and
a compound of Formula 2: 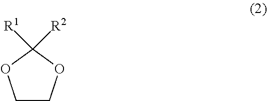
wherein R¹ and R² are H or a fluorinated methyl group, and at least one of R¹ and R² is a fluorinated methyl group,
wherein the compound of Formula 2 is present in an amount of about 1 to about 30% by weight of the liquid component of the battery electrolyte formulation, wherein diethyl sulfone is present in an amount of less than about 30% by weight of liquid components of the battery electrolyte formulation.

15. The formulation of claim 14, wherein R¹ is H, and R² is CHF₂ or CF₃.

16. The formulation of claim 14, wherein the compound of Formula 2 is present in an amount of about 2 to about 25% by weight of the liquid component of the battery electrolyte formulation.

17. The formulation of claim 14, wherein the compound of Formula 2 is present in an amount of about 6 to about 25% by weight of the liquid components of the battery electrolyte formulation.

18. The formulation of claim 14, wherein the compound of Formula 2 is present in an amount of about 12 to about 25% by weight of the liquid components of the battery electrolyte formulation.

19. The formulation of claim 14, wherein the charge carrying species comprises a metal electrolyte salt.

20. The formulation of claim 19, wherein the metal electrolyte salt is present in a concentration of 0.1 to 2M.

21. The formulation of claim 19, wherein the metal salt is a salt of lithium selected from the group comprising lithium hexafluorophosphate (LiPF₆), lithium perchlorate (LiClO₄), lithium tetrafluoroborate (LiBF₄), lithium triflate (LiSO₃CF₃), lithium bis(fluorosulphonyl)imide (Li(FSO₂)₂N), lithium bis(trifluoromethanesulphonyl)imide (Li(CF₃SO₂)₂N), and combinations thereof.

22. The formulation of claim 14, wherein at least one of the one or more solvents is selected from the group comprising ethylene carbonate (EC), diethyl carbonate (DEC), ethyl methyl carbonate (EMC), and mixtures thereof.

23. The formulation of claim 14, further comprising vinylene carbonate (VC).

24. The formulation of claim 14, which comprises less than 20% diethyl sulfone by weight of the battery electrolyte formulation.

25. The formulation of claim 24, which is substantially free from diethyl sulfone.

26. An electrochemical cell comprising an anode, a cathode, a separator membrane and an electrolyte formulation of claim 1.

27. An electrochemical cell comprising an anode, a cathode, a separator membrane and an electrolyte formulation of claim 14.
